(19) United States
(12) Patent Application Publication
(10) Pub. No.: US 2010/0284793 A1
(43) Pub. Date: Nov. 11, 2010

(54) METHOD OF ELECTRICAL DISCHARGE SURFACE REPAIR OF A VARIABLE VANE TRUNNION

(76) Inventors: Glenn Hong Guan Lee, Singapore (SG); Mohamed Salleh Najib, Singapore (SG); Siew Anna Tan, Singapore (SG); Kelvin Hon Kit Kuan, Singapore (SG)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/497,744

(22) Filed: Jul. 6, 2009

(30) Foreign Application Priority Data
May 8, 2009 (SG) 200903184.0

(51) Int. Cl. F01D 17/12; H05H 1/48

(52) U.S. Cl. 415/148; 427/580

(57) ABSTRACT

A method of repairing a variable vane for a gas turbine engine includes the steps of positioning a trunnion of a variable vane within an electrical discharge machine environment, and connecting the trunnion as a first electrode through an electrical discharge machine power generator to a second electrode. The second electrode is formed of a hard metal coating. A spark is created between the trunnion and the second electrode such that material from the second electrode is deposited on an outer surface of said trunnion. Further, a variable vane having a trunnion reconditioned by this method is disclosed and claimed.

### RELATED APPLICATION

This application claims priority to Singapore application number 200903184.0, which was filed May 8, 2009.

### BACKGROUND OF THE INVENTION

This application relates to a method of repairing a surface coating on a trunnion associated with a gas turbine engine variable vane.

Gas turbine engines are provided with vanes, which are positioned intermediate compressor rotors. The angle of incident of a variable vane can be changed by pivoting the variable vane on a trunnion, which is received within a bearing. The variable vanes may be exposed to extremely high temperatures, and thus may be provided with a hard metal coating for wear protection. As an example, tungsten carbide coatings are often utilized.

As a result of engine operation and environmental conditions, the coating can wear. At least some known methods of repairing a trunnion include to grind or otherwise mechanically machine-off the prior coating, and then re-coat the trunnion. Inevitably, during the machining process, some of the base material is removed together with the coating. This limits the ability to repair the part more than two or three times, as the trunnion will usually become undersized and will no longer meet acceptable government and/or industry requirements for returning the part back to service.

Electric discharge machining repair of various surfaces is also known. However, this surface repair has typically been utilized in the mold and die industry or to form steel rolls, and not to repair a prior coating.

### SUMMARY OF THE INVENTION

A method of repairing a variable vane for a gas turbine engine includes the steps of positioning a trunnion of a variable vane within an electrical discharge machine environment, and connecting the trunnion as a first electrode through an electrical discharge machine power generator to a second electrode. The second electrode (tool) is formed of a hard metal coating material. A spark is created between the trunnion and the tool electrode such that material from the tool electrode is deposited on an outer surface of said trunnion.

A variable vane for a gas turbine engine includes a vane having a trunnion at one end. The trunnion has outer surface provided with a hard metal coating. The outer surface of the hard metal coating includes a recast layer, a modified region positioned on an inner side of the recast layer, and a base material positioned on an opposed side of the modified region from the recast layer

These and other features of the present invention can be best understood from the following specification and drawings, the following of which is a brief description.

### BRIEF DESCRIPTION OF THE DRAWINGS

FIG. 1 schematically shows a gas turbine engine.

FIG. 2 shows a vane which is a part of the gas turbine engine of FIG. 1.

FIG. 3 schematically shows an exemplary arrangement for performing the method of this application.

FIG. 4 is a flow chart of an exemplary method.

### DETAILED DESCRIPTION OF THE PREFERRED EMBODIMENT

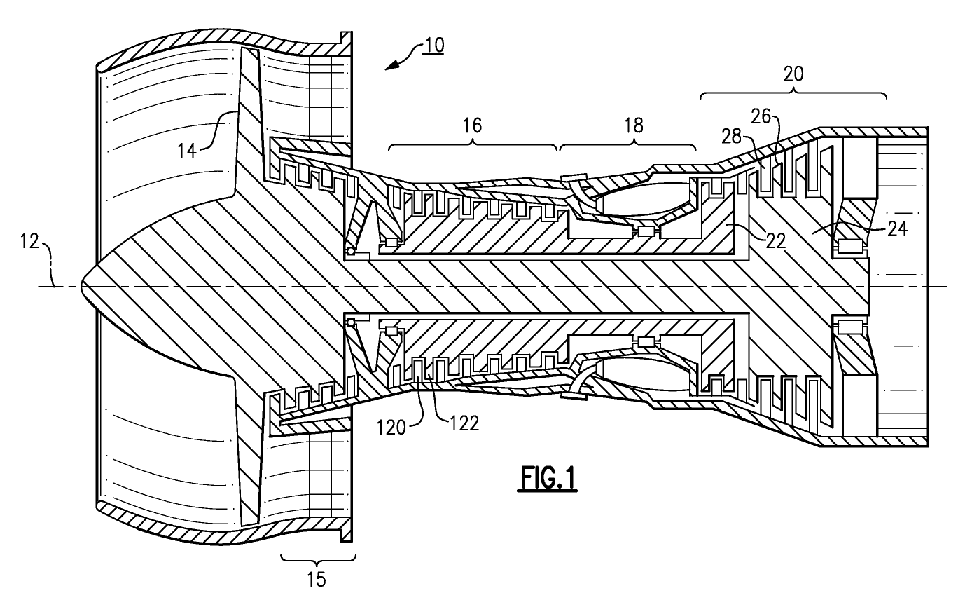

A gas turbine engine 10, such as a turbofan gas turbine engine, circumferentially disposed about an engine centerline, or axial centerline axis 12 is shown in FIG. 1. The engine 10 includes a fan 14, compressor sections 15 and 16, a combustion section 18 and a turbine 20. As is well known in the art, air compressed in the compressor 15/16 is mixed with fuel and burned in the combustion section 18 and expanded in turbine 20. The turbine 20 includes rotors 22 and 24, which rotate in response to the expansion. The turbine 20 includes alternating rows of rotary airfoils or blades 26 and static airfoils or vanes 28. In addition, the compressor sections 15 and 16 may incorporate vanes 120 and blades 122. The vanes 120 direct the compressed air, and may be variable vanes as described above. In fact, this view is quite schematic, and blades 26 and vanes 28 are actually removable. It should be understood that this view is included simply to provide a basic understanding of the sections in a gas turbine engine, and not to limit the disclosure. This disclosure extends to all types of turbine engines for all types of applications.

A variable vane 120, as may be incorporated into the compressor section 16 of FIG. 1 is illustrated in FIG. 2. As known, the vane can pivot as from a driving member, shown schematically at 100. The driving member 100 causes the vane 120 to pivot on trunnion 122. As mentioned above, the vane is typically provided with a hard metal coating and in particular, often provided with a tungsten carbide coating. With use, these coatings can wear.

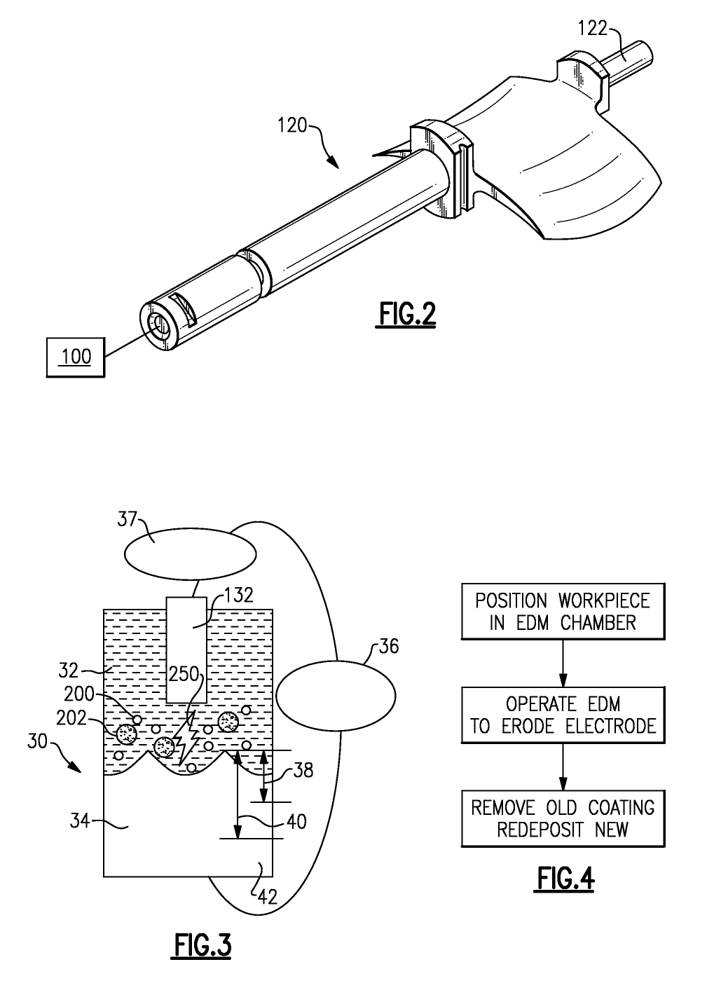

FIG. 3 shows an exemplary electrical discharge machine assembly for repairing a trunnion. As shown in FIG. 3, a work piece, which is the trunnion 34, is positioned within an electrical discharge machine chamber 30. A dielectric fluid 32 is incorporated into the chamber 30. An electrode 132 is connected to the trunnion 34 by an electrical discharge machine power generator 36, shown schematically. A servo system 37 connects the electrode 132 to the generator 36. In addition, the work piece or trunnion 34 acts as a second electrode, as known. In the dielectric fluid 32, particles 200 are pyrolytic carbon, and particles 202 are debris particles from tool wear.

The first electrode 132 may be formed of a hard metal coating, and in particular is formed of the coating that is to be deposited on the trunnion 34. In an exemplary embodiment, this coating is tungsten carbide.

During operation of the electrical discharge machine assembly, the material of the first electrode 132 is eroded and redeposited onto the trunnion 34. Additionally, some of the old coating is removed as the material of the first electrode 132 is deposited as the new coating. Compared to at least some known coating removal methods, little if any of the base material will be removed by the exemplary method.

As shown in FIG. 3, there is now a recast area 38, a modified region 40, and the underlying base material 42. An outermost surface of the coated trunnion 34 will be recast area or layer 38. Inwardly of this recast layer 38 is a modified region 40, and inwardly of the modified region 40, and on an opposed side of the modified region 40 from the recast layer 38, is the original base material 42. The relative sizes are simply shown as an example, and are not necessarily accurate. Moreover, there will not likely be a strict boundary between the layers.

The reconditioning of the prior hard metal coating is thus provided with the electrode discharge machine sparking to provide a spark 250, along with redeposit of new material on the coating. The bond orientation has no significant effect on tensile or fatigue properties, due to the ability of incorporating a sufficient amount of the tungsten carbide recast layer on the prior coating. There is a lesser likelihood of bond defects, abnormal grain structure or porosities than with the prior art method. Further, there is no restriction on repairing a complex component.

FIG. 4 is a brief flow chart of an exemplary method. First, a work piece is positioned in an electronic discharge machine chamber. The electronic discharge machine is then operated, and the electrode erodes. As the electrode erodes, the old coating will be removed from the work piece, and the new electrode coating will be redeposited.

Although this disclosure has been discussed with respect to an exemplary embodiment, a worker of ordinary skill in this art would recognize that certain modifications would come within the scope of this disclosure. For that reason, the following claims should be studied to determine the true scope and content of this disclosure.

What is claimed is:

1. A method of repairing a variable vane for a gas turbine engine comprising the steps of:
(a) positioning a trunnion of a variable vane within an electrical discharge machine assembly, said trunnion having a hard metal coating;
(b) connecting the trunnion as a first electrode through an electrical discharge machine power generator to a second electrode, said second electrode being formed of a hard metal coating; and
(c) creating a spark between said trunnion and said second electrode such that material from said second electrode is deposited on an outer surface of said trunnion.

2. The method as set forth in claim 1, wherein said second electrode is formed of substantially the same hard metal coating as the hard metal coating on said trunnion.

3. The method as set forth in claim 2, wherein said second electrode is formed of tungsten carbide.

4. The method as set forth in claim 1, wherein the material from said second electrode that is deposited on an outer surface of said trunnion results in an outer recast layer on the outer surface of the trunnion, a modified region on an inner side of said recast layer, and a base material on an opposed side of said modified region from said recast layer.

5. A variable vane for a gas turbine engine comprising:
a vane having a trunnion at one end; and
said trunnion having an outer surface provided with a hard metal coating, said outer surface of said hard metal coating including a recast layer, a modified region positioned on an inner side of said recast layer, and a base material positioned on an opposed side of said modified region from said recast layer.

6. The variable vane as set forth in claim 5, wherein said hard metal coating is a tungsten carbide coating.
